(19) United States
(12) Patent Application Publication
(10) Pub. No.: US 2026/0212140 A1
(43) Pub. Date: Jul. 23, 2026

(54) MAGNETIC CARD READER COMPRISING A STATIONARY MAGNETIC READING HEAD AND A METAL STRIP

(71) Applicant: BANKS AND ACQUIRERS INTERNATIONAL HOLDING, SURESNES (FR)

(72) Inventors: Jo UTEN, SURESNES (FR); Pierre MOREL, SURESNES (FR)

(21) Appl. No.: 19/141,420

(22) PCT Filed: Dec. 22, 2023
(86) PCT No.: PCT/EP2023/087776

§ 371 Date: Jun. 20, 2025

(30) Foreign Application Priority Data
Dec. 23, 2022 (FR) 2214427

(51) Int. Cl. G06K 7/08

(52) U.S. Cl. CPC G06K 7/087

(57) ABSTRACT

A magnetic card reader including an electronic card which is intended to receive and process data from a magnetic card, a magnetic reading head which is intended to read data contained in a magnetic card and to transmit these data to the electronic card, and a zone for passage of a magnetic card, which includes guides which are intended to guide the magnetic card as it slides in the passage zone. The reading head is mounted so that it is stationary on the magnetic card reader. The guides comprise elastic deformation elements which are intended to deform the magnetic card when it slides in the passage zone so as to allow the magnetic card to be read. The elastic deformation elements are made of a material having a Young's modulus greater than 100,000 MPa.

### TECHNICAL FIELD OF THE INVENTION

The invention relates to the field of magnetic card readers and electronic payment terminals comprising such magnetic card readers.

### TECHNICAL BACKGROUND

To obtain a satisfactory reading of a magnetic strip of a magnetic card by a magnetic card reader, when passing the magnetic card in the reader, the magnetic reading head must be in contact with the magnetic strip of the magnetic card and the quality of this contact must be good. Since magnetic cards are rigid, deformable means for moving the magnetic reading head in order to press the magnetic reading head against the magnetic card as it slides in a guide member of the magnetic card reader have therefore been developed. The force applied on the magnetic reading head by these deformable means for moving the magnetic reading head must be calculated so as to avoid significantly increasing the insertion force required to pass the magnetic card in the card reader so that a user of the device does not feel that the magnetic card is blocked as it passes in the reader and to minimise the risk of incorrect reading of the magnetic strip caused by a jerky movement.

Such magnetic card readers have disadvantages. Firstly, they are fragile. Since the magnetic reading head moves, the electronic connection between this magnetic reading head and an electronic card of the magnetic card reader is in fact made by using a flexible printed circuit which, by nature, is fragile. In addition, such flexible printed circuits are expensive and complex to integrate when assembling the reader. Apart from flexible printed circuits, the deformable means for moving the head further comprise parts that are expensive, fragile and complex to implement during assembly. In particular, they must be adapted to each type of magnetic reading head. In addition, protection against the electromagnetic environment must be provided, such protection being complicated to implement since the magnetic reading head changes position regularly.

### SUMMARY OF THE INVENTION

The invention aims in particular to provide a magnetic card reader capable of reliably reading the data present on a magnetic card, which is robust, simple and inexpensive to manufacture.

The invention therefore relates to a magnetic card reader comprising:
an electronic card which is intended to receive and process data from a magnetic card,
a magnetic reading head which is intended to read data contained in at least one magnetic strip of a magnetic card and to transmit these data to the electronic card,
a zone for passage of a magnetic card, in which a magnetic card is intended to slide and which comprises guide means which are intended to guide the magnetic card as the magnetic card slides in the passage zone,
   characterised in that the reading head is mounted so that it is stationary on the magnetic card reader,
   in that the guide means comprise elastic deformation means which are intended to come into contact with the magnetic card so as to deform it when the magnetic card slides in the passage zone in order to allow the magnetic strip of the magnetic card to be read by the reading head, and
   in that the elastic deformation means are made of a material having a Young's modulus greater than 100,000 MPa, preferably 130,000 MPa.

Thus, since the magnetic reading head is mounted so that it is stationary on the reader, there is no need to use flexible printed circuits for the connection between the magnetic reading head and the electronic card, which reduces the manufacturing costs and simplifies the assembly of the magnetic card reader during its manufacture. In addition, the magnetic card reader thus obtained is also more robust due to the absence of a flexible printed circuit and deformable means for moving the head. The deformable means for moving the head are in fact fragile elements that are complex to implement on the reader. According to one embodiment, the magnetic reading head is welded to the electronic card, which makes it easier to assemble the magnetic reading head on the electronic card since no intermediate is necessary. The elimination of these intermediates not only simplifies assembly but also reduces manufacturing costs and makes the device more robust since, as the total number of parts in the device decreases, the overall risk of wear is reduced. In addition, welding the magnetic reading head directly to the electronic card improves the security of the magnetic card reader since, in this case, fraudulent interception of data transiting from the magnetic reading head to the electronic card is more complicated.

The fact that the elastic deformation means of the magnetic card are part of the guide means is advantageous since it is a part of the magnetic card reader which can easily be modified to be adapted to different types of magnetic cards or magnetic reading heads used in order to obtain the required force to be applied on the magnetic card.

The fact that the elastic deformation means are made of a material having a Young's modulus greater than 100,000 MPa can advantageously be used to reduce the size of the magnetic card reader. In fact, for elastic deformation means having a Young's modulus less than 100,000 MPa, for example between 2000 and 4000 MPa for elastic deformation means made of plastic material, these elastic deformation means must be very thick in order to obtain a counter-support force that is sufficient to deform the magnetic card when it slides in the passage zone so as to press it against the reading head and ensure that the magnetic reading strips of the magnetic card can be read under good conditions. In addition, the elastic deformation means made from materials having a Young's modulus less than 100,000 MPa must have complex geometries in order to provide a counter-support force that is large enough so that the data of the magnetic card can be read reliably. Thus, the use of elastic deformation means having a Young's modulus greater than 100,000 MPa, for example greater than 200,000 MPa, allows the use, for equivalent counter-support force, of elastic deformation means that are thinner and therefore smaller. In addition, simple shapes can be used to make the elastic deformation means, which, apart from reducing the size, reduces the manufacturing costs and complexity.

A magnetic card is an electronic card provided with a magnetic strip on which data are stored by magnetic recording. The magnetic strip of this magnetic card can thus be read by a magnetic reading head in order to obtain the data stored in this magnetic card and possibly transmit them to an electronic card which can then process these data. Magnetic cards are for example used as bank card, car park access card, identification card or secure room access card.

The invention may also comprise the following optional characteristics, taken alone or in combination.

The elastic deformation means are made of metal or metal alloy. The use of such materials offers several advantages. Firstly, these materials are not or virtually not affected by the temperature conditions to which magnetic card readers may be subjected. In fact, these materials retain their properties in particular for temperatures ranging from −20° C. to +70° C. This is not the case for other materials such as plastic which, in case of a very cold temperature, for example −20° C., becomes more rigid and fragile and presents a significant risk of cracking, and which, in case of very high temperature, for example +70° C., softens, which reduces the counter-support force that the elastic deformation means are capable of generating, thus leading to frequent reading errors. In addition, this softening causes a risk of permanent plastic deformation making the elastic deformation means non-functional. Secondly, unlike other materials, for example plastic materials, metal and metal alloys are more resistant and will not suffer permanent deformation due to fatigue. Thirdly, the use of elastic deformation means made of metal or metal alloy discharges the static electricity generated by the passage of the magnetic card more efficiently before reaching the reading head, which reduces the risk of damaging the latter or disturbing the reading of the magnetic strip. The metals and metal alloys that can be used are, for example, steel, stainless steel, platinum, titanium, chromium, bronze, beryllium bronze, copper or even brass.

Preferably, the elastic deformation means are made of stainless steel. This material is particularly resistant to the environmental conditions, whether in terms of temperature or humidity. The use of such a material thus extends the lifetime of the magnetic card reader, especially when it is positioned outdoors. The stainless steel used is for example stainless steel SUS304.

The elastic deformation means comprise a support blade which is intended to come into contact with the magnetic card so as to deform it when the magnetic card slides in the passage zone in order to allow the magnetic strip of the magnetic card to be read by the reading head. We understand that it is the deformation of the magnetic card and not the movement of the magnetic reading head which ensures a permanent contact between the magnetic strip of the magnetic card and the magnetic reading head, when the magnetic card slides in the passage zone. The deformation of the magnetic card is preferably such that the magnetic strip is in contact with the magnetic reading head over its entire length, in other words the magnetic strip is pressed against the magnetic reading head by the support blade from one of its longitudinal ends then slides such that the full length of the magnetic strip crosses the magnetic reading head up to its other longitudinal end. This ensures that the entire magnetic strip has been read correctly by the magnetic reading head. Using a support blade limits the size of the elastic deformation means. In fact, a blade has a thin, flat shape that takes up little space. It is possible to use a support blade since the elastic deformation means are made of a material having a Young's modulus greater than 100,000 MPa. In fact, for a Young's modulus less than 100,000 MPa, the blade would not be rigid enough to provide a counter-support force large enough to press the magnetic strip of the magnetic card against the magnetic reading head in order to read the magnetic strip reliably.

Advantageously, the support blade is arranged so that, during a first contact between a magnetic card sliding in the passage zone and the support blade, the angle formed between the plane containing the magnetic card and the tangent at the point of contact on the support blade is less than 45°, preferably less than 15°. Such an angle produces a counter-support force large enough for the magnetic strip of the magnetic card to be read reliably while minimising the insertion force that a user must provide when inserting and sliding the magnetic card in the passage zone. Note that an angle less than 45°could not be used with elastic deformation means having a Young's modulus less than 100,000 MPa since they would be unable to produce a counter-support force large enough to press the magnetic card against the magnetic reading head for the magnetic strip to be read reliably.

Advantageously, the support blade comprises at least one side flap preventing the magnetic card from being inserted in the passage zone in a predetermined undesired direction of insertion. An undesired direction of insertion is for example a direction of insertion which does not allow the magnetic strip of the magnetic card to be read by the reading head or a direction of insertion in which the magnetic card would be likely to damage a component of the magnetic card reader or the magnetic card itself. It is thus in particular possible to easily prevent a magnetic card from being inserted in the passage zone in a direction of insertion likely to damage one or more components of the magnetic card reader, such as the support blade or the magnetic reading head. Preferably, the side flap is obtained by a stamping technique that does not generate sharp edges.

The support blade comprises a first longitudinal end stationary relative to the magnetic card reader and a second longitudinal end movable in translation parallel to a longitudinal axis of the support blade. This is an easy way of allowing the support blade to move when a magnetic card slides in the passage zone, this movement making it possible, due to the elasticity of the elastic deformation means, to generate the counter-support force required to press the magnetic card against the magnetic reading head. This mobility of the second longitudinal end of the support blade advantageously reduces the insertion force applied by a user when they insert the magnetic card in the passage zone. The magnetic card can therefore slide in the passage zone without jerking, thus ensuring that its magnetic strip can be read by the magnetic reading head under good conditions. Reducing the insertion force also makes the magnetic card reader more comfortable to use by a user.

Advantageously, the first and second longitudinal ends of the support blade are connected together by a connecting part of the support blade which is convex towards the magnetic reading head, the curvature of the connecting part not inverting between the first and second longitudinal ends of the support blade. The fact that the curvature of the connecting part does not invert between the first and second longitudinal ends reduces the size of the support blade and simplifies its manufacture.

Advantageously, the magnetic card reader comprises a member for guiding the magnetic card forming a support for the support blade, this support blade being housed in a recess of this guide member so that the first and second longitudinal ends of the support blade are in contact with a bottom of the recess and so that the connecting part of the support blade projects outside the recess. This arrangement is particularly compact. In addition, the member for guiding the magnetic card can also be used to guide a movement of the second longitudinal end of the support blade.

Advantageously, the magnetic card reader comprises means for guiding in translation the second longitudinal end of the support blade comprising a shouldered pin, stationary relative to the magnetic card reader, which is intended to cooperate with a cutout for guiding the support blade in order to limit the movement of the second longitudinal end of the support blade only in a direction of translation parallel to a longitudinal axis of the support blade. It is thus possible to better control the movement of the second longitudinal end of the support blade and therefore to better control the counter-support force applied to the magnetic card. Preferably, the guide pin is made of metal or metal alloy. This improves the lifetime of the guide pin, especially as regards the wear caused by friction between this shouldered pin and the support blade. According to a particular embodiment, the shouldered pin consists of a screw and a spacer.

Advantageously, the elastic deformation means are interposed between the reading head and tamper detection means positioned in the magnetic card reader so as to limit the spacing between these tamper detection means and the reading head, the spacing preferably being less than the dimension of the reading head of the magnetic card reader, measured parallel to the spacing direction, so as to prevent an additional reading head from being fraudulently inserted between the reading head of the magnetic card reader and the tamper detection means. This improves the security of the magnetic card reader. In fact, reducing the spacing between the tamper detection means and the reading head prevents the fraudulent insertion of an additional reading head. Note that it is possible, or at least easier, to install tamper detection means, since the size of the elastic deformation means is reduced.

According to one embodiment, the recess of the member for guiding the magnetic card is interposed between the reading head of the magnetic card reader and the tamper detection means. This results in a particularly compact magnetic card reader.

Advantageously, the tamper detection means comprise a generally plate-shaped support whose faces are covered at least partially by a network of conductors connected to an electronic circuit triggering an alarm as soon as damage to a conductor is detected, in particular by destruction or short-circuiting. This further improves the security of the magnetic card reader. Such a network of conductors is commonly called a lattice. The tamper detection means are for example capable of detecting that the support has been damaged, in particular by drilling, or that the support has been removed from its location. When the alarm has been triggered, any means can be implemented to limit the consequences of the tampering.

The invention also relates to an electronic payment terminal comprising a magnetic card reader as described previously. Such a payment terminal according to the invention is especially advantageous when used outdoors and/or in self-service, where its improved security and/or its resistance to outdoor conditions are particularly useful.

### BRIEF DESCRIPTION OF THE FIGURES

The invention will be better understood on reading the description which follows, given purely by way of non-limiting example and referring to the attached drawings, in which:

FIG. 1 is a perspective view of an electronic payment terminal comprising a magnetic card reader according to the invention;

FIG. 2 is a cross-sectional view of the electronic payment terminal of FIG. 1;

FIG. 3 is a perspective view of the elastic deformation means and of the member for guiding the magnetic card; and

FIG. 4 is an exploded view showing a magnetic card and some of the components of the magnetic card reader of the payment terminal of FIGS. 1 and 2.

### DETAILED DESCRIPTION

We will now describe, in reference to FIGS. 1 to 4, one embodiment of a magnetic card 2 reader 1 according to the invention, integrated in an electronic payment terminal 3 according to the invention.

The electronic payment terminal 3 therefore comprises the magnetic card reader 1 according to the invention and a traditional smart card reader 4 (FIG. 1). The electronic payment terminal 3 comprises two side edges, one upper edge and one lower edge. The upper and lower edges are taken to be the usual orientations of use of an electronic payment terminal 3. Thus, the upper edge corresponds to the distal edge, in other words the longitudinal edge farthest away from the user when they use the electronic payment terminal 3 and the lower edge corresponds to the proximal edge, in other words the longitudinal edge closest to the user when they use the electronic payment terminal 3. In the present case, in addition to the traditional location of the smart card reader 4 at the lower edge, the magnetic card 2 reader 1 is also located at the lower edge of the electronic payment terminal 3. Obviously, according to other embodiments, the terminal could be different from an electronic payment terminal 3, for example a car park access control terminal, an identification terminal or a secure room access control terminal.

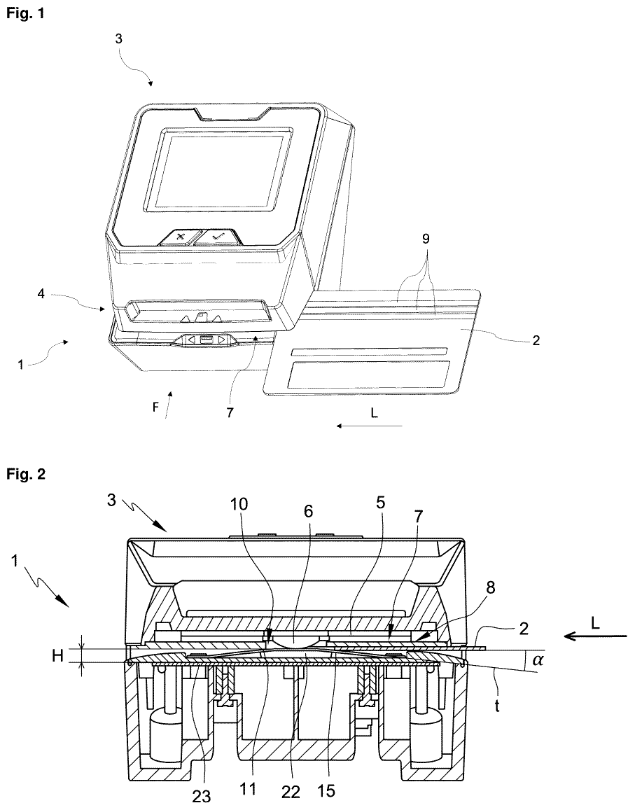

The magnetic card 2 reader 1 comprises in particular an electronic card 5, a magnetic reading head 6, a zone 7 for passage of a magnetic card 2 and means 8 for guiding the magnetic card 2 (FIG. 2).

In the present case, since the terminal is an electronic payment terminal 3, the magnetic card 2 is a payment card. It comprises three magnetic strips 9 intended for the magnetic storage of data. Obviously, the magnetic card 2 can comprise a different number of magnetic strips 9 depending on the embodiments.

The electronic card 5 is intended to receive and process data from the magnetic card 2, these data being read and transmitted by the magnetic reading head 6.

The magnetic reading head 6 is intended to read data contained in at least one of the magnetic strips 9 of the magnetic card 2 and to transmit these data to the electronic card 5 for processing therein. In the present case, the electronic card 2 comprises three magnetic strips 9 and the magnetic reading head 6 therefore comprises a box having three gaps each intended to read one of the magnetic strips 9 of the magnetic card 2. The magnetic reading head 6 is mounted so that it is stationary on the electronic card 5. More particularly, the magnetic reading head 6 is welded directly to the electronic card 5 (FIGS. 2 and 4). This avoids the need for connection intermediates and therefore reduces the production costs while making the device less fragile, such connection intermediates generally comprising parts that are subject to mechanical wear and fragile, such as a flexible printed circuit. Obviously, according to alternative embodiments, the magnetic reading head 6 could be attached to the electronic card 2 by any other suitable attachment means.

The zone 7 for passage of the magnetic card 2 consists of a slot formed in the lower edge of the electronic payment terminal 3. This passage zone 7 is that in which the magnetic card 2 is intended to slide when a user wants to use it on the electronic payment terminal 3. This zone 7 for passage of the magnetic card 2 comprises the guide means 8 which are intended to guide the magnetic card 2 when it slides in the slot.

In the present case, the guide means 8 comprise a guide member 15 and elastic deformation means 10 which are intended to come into contact with the magnetic card 2 so as to deform it when the magnetic card 2 slides in the passage zone 7—in other words in the slot—in order to allow the magnetic strips 9 of the magnetic card 2 to be read by the magnetic reading head 6.

In the present case, the elastic deformation means 10 comprise a support blade 11 which is intended to come into contact with the magnetic card 2 so as to deform it when the magnetic card 2 slides in the passage zone 7 in order to press the three magnetic strips 9 of the magnetic card 2 against the three gaps of the magnetic reading head 6 to guarantee a good quality contact between these elements. The elastic deformation means 10 are made of a material having a Young's modulus greater than 100,000 MPa, especially a metal or a metal alloy. Such a material allows the use of a support member having a thin, simple shape, in this case the shape of a support blade 11. In fact, with a lower Young's modulus, a support member that is thick and/or has a complex shape is required to generate a counter-support force that is large enough to press the magnetic strips 9 of the magnetic card 2 against the reading head 6 in order to read data under good conditions. Thus, it is not possible, for example, to consider a support member consisting of a blade made of a material having a Young's modulus less than 100,000 MPa, at the risk of obtaining a magnetic card 2 reader 1 with unsatisfactory reading reliability. In the present case, the support blade 11 is made of stainless steel, such as stainless steel SUS304. The use of stainless steel is advantageous since this material is particularly resistant to the environmental conditions, whether in terms of temperature or humidity, especially resistance to corrosion. The use of a metal or a metal alloy, for example stainless steel, makes it possible, for example, to ensure that the support blade 11 will continue to perform its function even under extreme temperature conditions, ranging for example from −20° C. to +70° C. The use of such materials thus extends the lifetime of the magnetic card reader, especially when it is positioned outdoors.

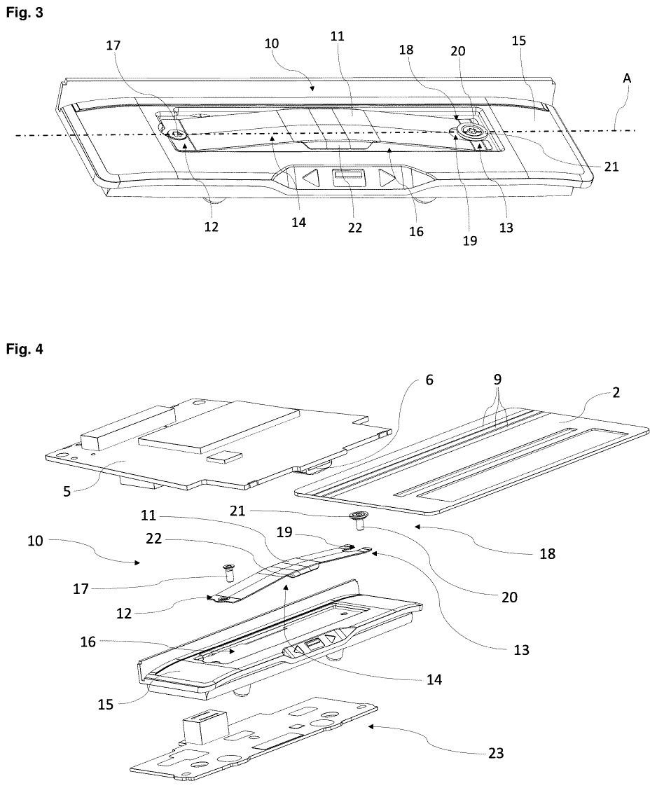

The support blade 11 comprises a first longitudinal end 12 stationary relative to the magnetic card 2 reader 1 and a second longitudinal end 13 movable in translation parallel to a longitudinal axis A of the support blade (FIG. 3). At its second longitudinal end 13, the support blade 11 comprises a cutout 19 for guiding the support blade 11. This cutout 19 can have different shapes depending on the embodiments. For example, the cutout could consist of an oblong hole.

The first and second longitudinal ends 12, 13 of the support blade 11 are connected together by a connecting part 14 of the support blade which is convex towards the magnetic reading head, the curvature of the connecting part not inverting between the first and second longitudinal ends of the support blade (FIGS. 3 and 4). The shape of the support blade 11, and in particular the fact that its connecting part 14 has a curvature that does not invert between the longitudinal ends 12, 13, reduces the size of the elastic deformation means 10. The magnetic card 2 reader 1 is thus more compact. Obviously, according to other embodiments, the support blade 11 could have a different shape.

As indicated previously, the guide means 8 comprise a member 15 for guiding the magnetic card 2. This guide member 15 forms a support for the support blade 11 (FIG. 3). The guide member 15 extends substantially over the entire length of the passage zone 7 and comprises a recess 16. The support blade 11 is housed in this recess 16 so that the first and second longitudinal ends 12, 13 of the support blade 11 are in contact with a bottom of the recess 16 and so that the connecting part 14 of the support blade 11 projects outside the recess 16 (FIG. 3). The recess 16 makes the magnetic card 2 reader 1 even more compact.

The support blade 11 is attached in the bottom of the recess 16 at its two longitudinal ends 12, 13. As indicated previously, the first longitudinal end 12 of the support blade 11 is attached with no freedom of movement. This attachment is carried out for example in the present case using an attachment screw 17 (FIGS. 3 and 4). Concerning the second longitudinal end 13 of the support blade, the magnetic card 2 reader 1 comprises means 18 for guiding in translation the second longitudinal end 13 of the support blade 11 (FIGS. 3 and 4). These guide means 18 comprise a shouldered pin, stationary relative to the magnetic card 2 reader 1. This shouldered pin consists in the present case of a guide screw 20 and a spacer 21 (FIGS. 3 and 4). According to other embodiments, the shouldered pin has a different shape. For example, the guide pin is made in one piece. The guide screw 20 and the spacer 21 are intended to cooperate with the cutout 19 for guiding the support blade 11 so as to limit the movement of the second longitudinal end 13 of the support blade 11 only in a direction of translation parallel to the longitudinal axis A of the support blade 11 (FIG. 3). The movement of the support blade 11 when inserting the magnetic card 2 is thus controlled and it is easier to control the counter-support force that the support blade 11 will provide.

FIG. 2 shows the magnetic card 2 as it slides in the passage zone 7 where it comes into contact with the support blade 11, before the latter deforms the magnetic card 2. Note that the support blade 11 is arranged so that, during a first contact between the magnetic card 2 sliding in the passage zone 7 and the support blade 11, the angle & formed between the plane containing the magnetic card 2 and the tangent t at the point of contact on the support blade 11 is less than 45°. Such an angle α produces a counter-support force large enough for the magnetic strips 9 of the magnetic card 2 to be read reliably by the magnetic reading head 6 while minimising the insertion force that a user must provide when inserting and sliding the magnetic card in the passage zone. Note that preferably, the angle α is less than 15°to allow an optimum counter-support force for the magnetic strips 9 of the magnetic card 2 to be read reliably by the magnetic reading head 6 while minimising the insertion force that a user must provide when inserting and sliding the magnetic card in the passage zone. In the example described, the angle α is 7°.

The support blade 11 comprises two side flaps 22 preventing the magnetic card 2 from being inserted in the passage zone 7 in a predetermined undesired direction of insertion. As shown for example on FIGS. 1 and 2, in the present case the desired direction of insertion L is a lateral direction, in other words going from one side edge to the other of the magnetic card 2 reader 1. In this case, the front side flap 22 prevents insertion from the front, in other words from the lower edge to the upper edge of the magnetic card 2 reader 1. This direction of insertion F is not desired for several reasons. Firstly, concerning the arrangement of the magnetic reading head 6, the insertion of a magnetic card 2 in a front direction of insertion F would not allow the magnetic strips 9 of the magnetic card 2 to be read by the magnetic reading head 6. In addition, insertion of the magnetic card 2 from the front presents a risk of damaging the magnetic card 2 reader 1, in particular a risk of damaging the support blade 11 or the magnetic reading head 6. In the present case, the side flaps 22 have been formed by stamping to avoid generating sharp edges on the support blade 11. The number of side flaps 22 varies depending on the embodiments. For example, the support blade 11 could only comprise the front side flap 22.

The magnetic card 2 reader 1 further comprises tamper detection means 23 positioned in the magnetic card reader 1 so as to limit the spacing H between these tamper detection means 23 and the reading head 6 (FIGS. 2 and 4). In the present case, the tamper means 23 are attached under the guide member 15 so that the elastic deformation means 10 are interposed between the reading head 6 and the tamper detection means 23. The spacing H is preferably less than the dimension of the reading head 6 of the magnetic card 2 reader 1, measured parallel to the spacing direction, to prevent a reading head from being fraudulently inserted between the reading head 6 of the magnetic card 2 reader 1 and the tamper detection means 23. We therefore understand that this spacing H varies depending on the embodiments, in particular depending on the reading heads 6 that can be used with a given magnetic card 2 reader 1. Note that it is possible to install tamper detection means 23 since the size of the support blade 11 is reduced.

The recess 16 of the member 15 for guiding the magnetic card 2 is interposed between the reading head 6 and the tamper detection means 23.

In the present case, the tamper detection means 23 comprise a generally plate-shaped support whose faces are covered at least partially by a network of conductors, also called lattice, connected to an electronic circuit, for example the electronic circuit of the electronic card 5, triggering an alarm as soon as damage to at least one of the conductors is detected, in particular damage by destruction-drilling for example-or short-circuiting. The security of the magnetic card 2 reader 1 is thus improved since an attempt to fraudulently insert a reading head in the passage zone 7 can easily be detected.

We will now describe the operation of the electronic payment terminal 3 comprising the magnetic card 2 reader 1 according to the embodiment of the invention described above.

When a user wants to make a payment with their magnetic card 2, which is therefore in this case a bank card, they insert it in the zone 7 for passage of the magnetic card 2 consisting of the slot formed in the lower edge of the electronic payment terminal 3 with the magnetic strips 9 of the magnetic card 2 directed upwards in reference to FIGS. 1 to 4. The user slides the magnetic card 2 in the direction of insertion L in this slot and the magnetic card 2 is, initially, guided by guide means 8 consisting of the walls of the box of the electronic payment terminal 3 and the guide member 15. The magnetic card 2 is in particular pressed in the bottom of the slot by its upper edge. The user continues to slide the magnetic card 2 in the direction of insertion L and, when the magnetic card 2 reaches the support blade 11 of the elastic deformation means 10, the magnetic card 2 moves this support blade 11 against the force of its elastic return force and the latter exerts in return an elastic force against the magnetic card 2 so as to deform it and press the parts of the magnetic strips 9 which pass opposite the gaps of the magnetic reading head 6 against these gaps.

As indicated previously, note that the first contact between the magnetic card 2 and the support blade 11 is made with an angle α which is small enough to simplify the movement of the support blade 11 and so that a user does not feel that the card is blocked as it slides. The support blade 11 is thus configured so that the counter-support force applied on the magnetic card 2 is high enough to deform the magnetic card 2 sufficiently in order to establish a satisfactory contact with the magnetic reading head 6 and low enough to avoid creating for the user a feeling of blocking or discontinuity in the sliding movement of the magnetic card 2. Apart from being prejudicial to the user's experience, such a discontinuity in the sliding movement would also impair the reading quality of the magnetic card 2.

As the magnetic card 2 slides, the support blade 11 presses successively a part of the magnetic strips 9 opposite the gaps of the magnetic reading head 6 such that when sliding stops, the three magnetic strips 9 have each been read over their entire length. Once the support blade 11 is no longer moved by the magnetic card 2, it is returned elastically to the rest position, ready to press another magnetic card 2 against the magnetic reading head 6. The data which have been read by the magnetic reading head 6 are transmitted directly to the electronic card 5 which can process them in a known manner.

If an attempt is made to fraudulently insert a magnetic reading head in the passage zone 7, for example by attempting to insert a reading head in the passage zone 7 from underneath in reference to FIGS. 1 to 4, note that access to the passage zone 7 is blocked by the support of the tamper detection means 23. Thus, in order to fraudulently insert a magnetic reading head, these tamper detection means 23 would have to be damaged or removed, thus triggering the alarm. In addition, even if, for any reason, the alarm should not be triggered, the spacing H is small enough to prevent the insertion of a second reading head in the passage zone 7 so that fraudulent insertion is not possible.

The invention is not limited to the embodiments described and other embodiments will be clearly apparent to those skilled in the art.

### List of References

1: magnetic card reader
2: magnetic card
3: electronic payment terminal
4: smart card reader
5: electronic card
6: magnetic reading head
7: zone for passage of a magnetic card
8: means for guiding a magnetic card
9: magnetic strip
10: elastic deformation means
11: support blade
12: first longitudinal end of the support blade
13: second longitudinal end of the support blade
14: connecting part between the longitudinal ends of the support blade
15: member for guiding the magnetic card
16: recess
17: attachment screw
18: means for guiding in translation the support blade
19: cutout for guiding the support blade
20: guide screw
21: spacer
22: side flap
23: tamper detection means
α: angle between the plane of the magnetic card and the tangent at the point of contact with the support blade
t: tangent at the point of contact between the support blade and the magnetic card
A: longitudinal axis of the support blade
F: undesired direction of insertion
L: direction of insertion
H: spacing between the tamper detection means and the reading head

1. 1. A magnetic card reader, comprising:
an electronic card which is intended to receive and process data from a magnetic card,
a magnetic reading head which is intended to read data contained in at least one magnetic strip of the magnetic card and to transmit these data to the electronic card,
a zone for passage of the magnetic card, in which the magnetic card is intended to slide and which comprises guide means which are intended to guide the magnetic card as the magnetic card slides in the passage zone,
wherein the magnetic reading head is mounted so that it is stationary on the magnetic card reader,
wherein the guide means comprise elastic deformation means which are intended to come into contact with the magnetic card so as to deform it when the magnetic card slides in the passage zone in order to allow the magnetic strip of the magnetic card to be read by the magnetic reading head, and
in thatwherein the elastic deformation means are made of a material having a Young's modulus greater than 100,000 MPa.

2. The magnetic card reader according to claim 1, wherein the elastic deformation means are made of metal or metal alloy.

3. The magnetic card reader according to claim 2, wherein the elastic deformation means are made of stainless steel.

4. The magnetic card reader according to claim 1, wherein the elastic deformation means comprise a support blade which is intended to come into contact with the magnetic card so as to deform it when the magnetic card slides in the passage zone in order to allow the magnetic strip of the magnetic card to be read by the magnetic reading head.

5. The magnetic card reader according to claim 4, wherein the support blade is arranged so that, during a first contact between the magnetic card sliding in the passage zone and the support blade, an angle (α) formed between a plane containing the magnetic card and a tangent (t) at a point of contact on the support blade is less than 45°. preferably

6. The magnetic card reader according to claim 4, wherein, the support blade comprises at least one side flap preventing the magnetic card from being inserted in the passage zone in a predetermined undesired direction of insertion.

7. The magnetic card reader according to claim 4, wherein the support blade comprises a first longitudinal end stationary relative to the magnetic card reader and a second longitudinal end movable in translation parallel to a longitudinal axis of the support blade.

8. The magnetic card reader according to claim 7, wherein the first and second longitudinal ends of the support blade are connected together by a connecting part of the support blade which is convex towards the magnetic reading head, a curvature of the connecting part not inverting between the first and second longitudinal ends of the support blade.

9. The magnetic card reader according to claim 8, comprising a member for guiding the magnetic card forming a support for the support blade, this support blade being housed in a recess of this guide member so that the first and second longitudinal ends of the support blade are in contact with a bottom of the recess and so that the connecting part of the support blade projects outside the recess

10. The magnetic card reader according to claim 7, comprising means for guiding in translation the second longitudinal end of the support blade comprising a shouldered pin, stationary relative to the magnetic card reader, which is intended to cooperate with a cutout for guiding the support blade in order to limit movement of the second longitudinal end of the support blade only in a direction of translation parallel to the longitudinal axis of the support blade.

11. The magnetic card reader according to claim 1, wherein the elastic deformation means are interposed between the magnetic reading head and tamper detection means positioned in the magnetic card reader so as to limit the spacing between these tamper detection means and the magnetic reading head.

12. The magnetic card reader according to claim 9, wherein the elastic deformation means are interposed between the magnetic reading head and tamper detection means positioned in the magnetic card reader so as to limit spacing between these tamper detection means and the magnetic reading head, wherein the recess of the member for guiding the magnetic card is interposed between the magnetic reading head of the reader and the tamper detection means.

13. The magnetic card reader according to claim 11, wherein the tamper detection means comprise a generally plate-shaped support whose faces are covered at least partially by a network of conductors connected to an electronic circuit triggering an alarm as soon as damage to a conductor is detected, in particular by destruction or short-circuiting.

14. An electronic payment terminal comprising the magnetic card reader according to claim.

15. The magnetic card reader according to claim 5, wherein the angle (α) is less than 15°.

16. The magnetic card reader according to claim 11, wherein the spacing is less than a dimension of the magnetic reading head of the magnetic card reader, measured parallel to a spacing direction, so as to prevent an additional reading head from being fraudulently inserted between the magnetic reading head of the magnetic card reader and the tamper detection means.
